(19) United States
(12) Patent Application Publication
(10) Pub. No.: US 2023/0060951 A1
(43) Pub. Date: Mar. 2, 2023

(54) High Temperature Polymer Adhesive and Laminate Using the Adhesive

(71) Applicant: Custom Laminating Corp., Mt. Bethel, PA (US)

(72) Inventors: Michael Zajaczkowski, Bellefonte, PA (US); Cynthia Cain, Flemington, NJ (US)

(73) Assignee: Custom Laminating Corp., Mt. Bethel, PA (US)

(21) Appl. No.: 17/794,330

(22) PCT Filed: Jan. 22, 2021
(86) PCT No.: PCT/US2021/014484

§ 371 Date: Jul. 21, 2022

Related U.S. Application Data
(60) Provisional application No. 62/964,391, filed on Jan. 22, 2020.

(51) Int. Cl. B32B 7/12; C09J 123/08; C09J 123/14; C08K 5/20; C08K 5/3492; C08K 5/3412

(52) U.S. Cl. CPC B32B 7/12; C09J 123/08; C09J 123/14; C08K 5/20; C08K 5/34922; C08K 5/3412; C09J 2301/16; C09J 2423/04; C09J 2423/10; B32B 2250/02; B32B 2250/03; B32B 2250/04

(57) ABSTRACT

A polymer adhesive includes a polymer base comprising an ethylene and/or propylene copolymer and a crosslinking agent selected from the group consisting of hydroxyalkyl amides, melamines, and aziridines. A laminate includes a first substrate, a second substrate, and the polymer adhesive between the first substrate and the second substrate.

### CROSS-REFERENCE TO RELATED APPLICATION

The present application claims the benefit of U.S. Provisional Patent application Ser. No. 62/964,391, filed on Jan. 22, 2020, which is incorporated herein by reference in its entirety.

### BACKGROUND OF THE INVENTION

### Field of the Invention

The present invention relates to a polymer system that serves as a laminating adhesive where high temperature and solvent resistance are required.

### Description of the Related Art

Adhesives are used to connect different layers of substrate material together to form a laminate. The substrate material can be the same material or different material. Oftentimes, such laminates can be subjected to extreme temperatures that may cause the adhesive to lose its adherence properties, resulting in delamination of the laminate.

It would be beneficial to provide an adhesive for laminating substrates that can withstand extreme temperatures.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a polymer adhesive comprising a polymer base comprising an olefin polymer containing ethylene and/or propylene repeat units and a crosslinking agent selected from the group consisting of hydroxyalkyl amides, isocyanates, melamines, melamine formaldehyde resins, epoxies, metal chelates, polyfunctional amines, polyfunctional mercaptans, polyamide epichlorohydrin resins, di and multifunctional hydrazides, oxazolines and aziridines.

In another embodiment, the present invention is a laminate that includes a first substrate, a second substrate, and the polymer adhesive between the first substrate and the second substrate.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a side elevational view of an exemplary laminate using the inventive adhesive; and

FIG. 2 is a side elevational view of an alternative exemplary laminate using the inventive adhesive.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.” Unless explicitly stated otherwise, each numerical value and range should be interpreted as being approximate as if the word “about” or “approximately” preceded the value of the value or range.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The present invention provides a polymer system that serves as a laminating adhesive where high temperature and solvent resistance are required.

In an exemplary embodiment, the inventive polymer system includes a polymer base that is an ethylene or propylene copolymer. Examples are ethylene-(meth)acrylic acid, ethylene-vinyl acetate, ethylene-alkyl (meth)acrylate copolymers, propylene maleic anhydride copolymers, chlorinated olefins.

The polymer system also contains a crosslinking agent such as, for example, hydroxyalkyl amides, melamines, and aziridines. An exemplary list of crosslinkers is disclosed in U.S. Pat. No. 10,100,233 and includes self-reactive isocyanate, melamine formaldehyde, anhydride, epoxy, titanium esters and chelates, aziridines, isocyanate, carbodiimides, metal chelates, titanium esters and oxazolines, carboxylic acid, amine, hydroxyl, addition reaction with silicone hydride, mercaptan, self-reactive with radical catalyst (UV, thermal), acetoacetate, phosphoric acid, mercaptan isocyanate, melamine formaldehyde, anhydride, acrylate.

In an exemplary embodiment, the polymer base comprises between about 75 weight percent and about 99.99 weight percent, while the crosslinker comprises between about 0.01 weight percent to about 25 weight percent. In an exemplary embodiment, the crosslinker comprises between about most preferably 1 weight percent and about 15 weight percent. The amount of crosslinker is dependent on the desired modulus of the cured adhesive.

Activation temperature for bonding the adhesive starts at about 80° C. and crosslinking can occur at ambient temperatures (about 25° C.) up to 200° C., depending on the crosslinker employed. Additives that can enhance performance are listed in U.S. Pat. No. 9,976,065, Columns 8 and 9. One potentially useful additive is flame retardant, particularly non-halogenated flame retardants, many of which are listed in U.S. Pat. No. 5,851,663.

Substrates to be bonded with the present adhesive can include polyethylene terephthalate (PET), metalized PET, polypropylene, polyethylene, metalized polypropylene, ceramic sheet materials, nylon, vinyl, scrims and foams. Further examples of substrates for laminates are fabrics, nonwoven fabrics, nonwoven veils, nonwoven mats, which may be constructed of fibers using one or more natural or synthetic fibers made of materials such as, for example, cotton, wool, rayon, nylon, polyester, polyalkylene, modacrylic fibers, glass, or ceramics.

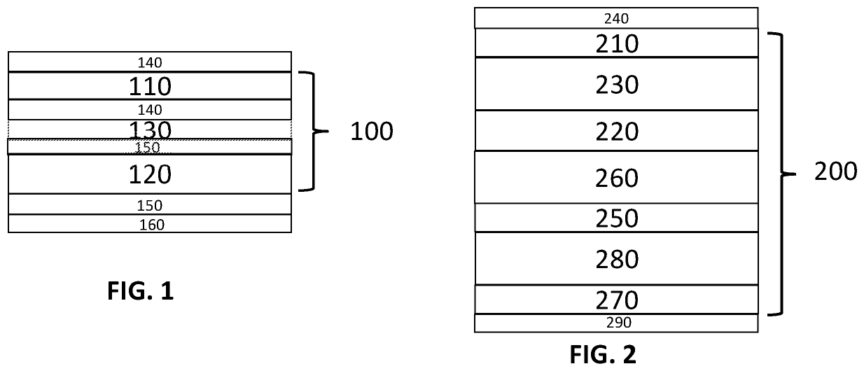

Referring to FIG. 1, a laminate 100 can be formed with a first substrate 110 bonded to a second substrate 120 with the inventive adhesive 130 between the first substrate 110 and the second substrate 120. The laminate 100 requires a pull force of at least 0.5 pounds per inch of width to separate the first substrate from the second substrate.

Substrates 110, 120 can be films, foils, woven fabric, non-woven fabric or other suitable material. Optionally, metallization layers 140, 150 can be applied to exposed sides of substrates 110, 120. Metallization layer can be Al₂O₃. Still optionally, a coating 160 can be applied to the exposed side of at least one of metallization layers 140, 150. Optionally, as shown in FIG. 1, metallization layers 140, 150 can be applied to both sides of substrates 110, 120.

Referring to FIG. 2, an alternative laminate 200 can be formed with a first substrate 210 bonded to a second substrate 220 with the inventive adhesive 230 between the first substrate 210 and the second substrate 220. The laminate 200 requires a pull force of at least 0.5 pounds per inch of width to separate the first substrate from the second substrate.

Substrates 210, 220 can be films, foils, woven fabric, non-woven fabric or other suitable material. Optionally, a metallization layers 240 can be applied to exposed sides of substrate 210. Metallization layer can be Al₂O₃. Additional layers of a substrate 250 can be applied to substrate 230 with an adhesive 260 and a substrate 270 can be applied to substrate 250 with an adhesive 280. Adhesives 260, 280 can be the same or different from the inventive adhesive 230. Still optionally, a coating 290 can be applied to the exposed side of substrate 280.

### EXAMPLES

The following are examples of laminates and adhesives according to the present invention. Table 1 provides a list of materials used in those examples.

TABLE 1
Description

Ethylene Acrylic Acid copolymer dispersion, 28-
30% in water
Ethylene Acrylic acid ionomer copolymer
dispersion, 35% in water
Propylene based Maleated Polyolefin dispersion,
28.5-31.5% active matter in water with a polymer
melt temperature (Tm) of 70° C.
Propylene based Maleated Polyolefin dispersion,
28-32% active matter in water with a polymer
melt temperature (Tm) of 80° C.
Ethylene Acrylic Acid copolymer dispersion, 24.2-
25.4% in water
Ethylene Acrylic Acid copolymer dispersion, 44.0-
46.0% in water
β-hydroxyalkylamide crosslinker, used as a 33%
solution in water
Highly methylated, monomeric melamine
crosslinking resin which consists of ≥97% non-
volatile matter
Methylated/n-butylated, high imino melamine
crosslinker supplied in n-butanol, 80-84% non-
volatile matter
Unalkylated glycoluril crosslinker supplied in
water at 43-47% non-volatile matter
Polyoxazoline copolymer crosslinking resin, 25%
active matter in water
Multi-functional carbodiimide viscous liquid
crosslinker which is 100% active matter with an
equivalent weight of 700
Ethoxylated acetylenic gemini surfactant, 100%
active matter
Associative Thickener, 20% active matter in water
Foam control agent, 100% active matter
Nano-scale wax emulsion anti block agent, 24.5-
25.5% in water
Aqueous emulsion of phosphonate oligomers
Blue Dye Solution 0.1% in water

### Safety and Protective FR Rayon Laminates

### Experimental Procedures

The polymer blends and waterborne formulations in Table 2 and 3 were mixed with an electric mixer at low speed using a 1.5 inch diameter propeller blade. The crosslinker was added while the base polymer was being agitated and mixing continued for 5 minutes after addition to fully incorporate the crosslinkers and additives. A film casting knife was used to coat the adhesives onto the metalized side of 0.00048 inch metalized PET at an approximate coat weight of 30 pounds/ream. Coatings were dried for 10-15 minutes at 75-85° C. before laminating to the textured side of FR Rayon sheets using a ChemInstruments HL-100 Hot Roll Laminator. Lamination temperatures ranged from 330-400° F., speeds ranged from 50-300 inches/min and pressure was 90 PSI.

T-peel testing was done according to ASTM D1876-08, Standard Method for Peel Resistance of Adhesives, with a Mark-10 Model M5-20 force gauge at a speed of 3 in/min. Average force in pounds is reported.

High Temperature Creep testing was performed in a 225° C. oven. A 2 inch wide by 10 inch long piece was cut from the laminate so that the top 1-2 inches were not bonded. The free piece of MPET was reinforced with masking tape and a 50 gram weight was hung from it, while the free fabric side was clamped to the oven rack with a binder clip. The oven rack was placed into the oven for 5 minutes. Less than 1 inch of debonding indicates a passing result.

Wet Flex testing involved soaking a 4 inch wide by 8 inch long laminate in a 140±5° F. water bath for 15 minutes, blotting the sample with absorbent cloths and clamping it into a flexing device (as described in MIL-C-87076A). After flexing for 1000 cycles, samples were inspected visually for delamination and cracking.

### Results

As shown in Table 2, several waterborne polymers and polymer blends were evaluated (P1-5) and most produced strong or destructible bonds (P1-4). However, without crosslinking they had insufficient heat resistance for the application.

TABLE 2
Polymer Evaluations

| Material | P1 | P2 | P3 | P4 | P5 |
|---|---|---|---|---|---|
| Ethylene Acrylic Acid | 100 | 54.7 | — | — | — |
| copolymer dispersion, | | | | | |
| 28-30% in water | | | | | |
| Ethylene Acrylic acid | — | 45.3 | — | — | — |
| ionomer copolymer | | | | | |
| dispersion, 35% in | | | | | |
| water | | | | | |
| Propylene based | — | — | 100 | — | — |
| Maleated | | | | | |
| Polyolefin dispersion, | | | | | |
| 28.5-31.5% active | | | | | |
| matter in water with | | | | | |
| a polymer melt | | | | | |
| temperature (Tm) | | | | | |
| of 70° C. | | | | | |
| Propylene based | — | — | — | 100 | — |
| Maleated Polyolefin | | | | | |
| dispersion, 28-32% | | | | | |
| active matter in water | | | | | |
| with a polymer melt | | | | | |
| temperature (Tm) of | | | | | |
| 80° C. | | | | | |
| Ethylene Acrylic Acid | — | — | — | — | 100 |
| copolymer dispersion, | | | | | |
| 24.2-25.4% in water | | | | | |
| Test Results | | | | | |
| T-Peel (lbf/in) | D | D | 5.9 | 4.6 | 1.7 |

D = Destructible

With the addition of crosslinker, adhesive formulations of the present invention (Example 1-4) passed the high temperature creep test, as shown in Table 3. Example 4 passed creep even with a significant loading of flame retardant. In contrast, Comparative Examples 1 and 2 failed the high temperature creep test. Example 1, 3 and 4 held together during wet flex testing but had some delamination after flexing. Example 4 passed the wet flex test with no delamination or cracking, when a urethane-primed double-metallized PET film was used. All formulas in Table 2 and 3 are given in parts.

TABLE 3
Adhesive Formulas

| | | | | | Com- | Com- |
|---|---|---|---|---|---|---|
| | | | | | par- | par- |
| | Ex- | Ex- | Ex- | Ex- | ative | ative |
| | am- | am- | am- | am- | Exam- | Exam- |
| Material | ple 1 | ple 2 | ple 3 | ple 4 | ple 1 | ple 2 |
| Ethylene Acrylic Acid | 100 | 100 | — | — | 100 | 100 |
| copolymer | | | | | | |
| dispersion, 28-30% in | | | | | | |
| water | | | | | | |
| Propylene based | — | — | 50 | — | — | — |
| Maleated Polyolefin | | | | | | |
| dispersion, 28.5- | | | | | | |
| 31.5% active matter | | | | | | |
| in water with a | | | | | | |
| polymer melt | | | | | | |
| temperature (Tm) of | | | | | | |
| 70° C. | | | | | | |
| Propylene based | — | — | 50 | — | — | — |
| Maleated Polyolefin | | | | | | |
| dispersion, 28-32% | | | | | | |
| active matter in | | | | | | |
| water with a | | | | | | |
| polymer melt | | | | | | |
| temperature (Tm) of | | | | | | |
| 80° C. | | | | | | |
| Ethylene Acrylic Acid | — | — | — | 100 | — | — |
| copolymer | | | | | | |
| dispersion, 44.0- | | | | | | |
| 46.0% in water | | | | | | |
| Aqueous emulsion of | — | — | — | 40.5 | — | — |
| phosphonate | | | | | | |
| oligomers | | | | | | |
| Highly methylated, | 1.5 | — | 1.6 | — | — | — |
| monomeric | | | | | | |
| melamine | | | | | | |
| crosslinking resin | | | | | | |
| which consists of | | | | | | |
| ≥97% non-volatile | | | | | | |
| matter | | | | | | |
| Polyoxazoline | — | 6.1 | — | — | — | — |
| copolymer | | | | | | |
| crosslinking resin, | | | | | | |
| 25% active matter in | | | | | | |
| water | | | | | | |
| Methylated/n- | — | — | — | 4.6 | — | — |
| butylated, high imino | | | | | | |
| melamine crosslinker | | | | | | |
| supplied in n- | | | | | | |
| butanol, 80-84% | | | | | | |
| non-volatile matter | | | | | | |
| Multi-functional | — | — | — | — | 0.9 | — |
| carbodiimide viscous | | | | | | |
| liquid crosslinker | | | | | | |
| which is 100% active | | | | | | |
| matter with an | | | | | | |
| equivalent weight of | | | | | | |
| 700 | | | | | | |
| Unalkylated | — | — | — | — | — | 8.1 |
| glycoluril crosslinker | | | | | | |
| supplied in | | | | | | |
| water at 43-47% | | | | | | |
| non-volatile matter | | | | | | |
| Ethoxylated | — | — | — | 1.5 | — | — |
| acetylenic gemini | | | | | | |
| surfactant, 100% | | | | | | |
| active matter | | | | | | |
| Associative | — | — | — | — | 0.5 | — |
| Thickener, 20% | | | | | | |
| active matter in | | | | | | |
| water | | | | | | |
| Foam control agent, | — | — | — | — | 0.1 | — |
| 100% active matter | | | | | | |
| Evaluation | | | | | | |
| T-Peel (lbf/in) | D | D | D | D | D | — |
| High Temperature | Pass | Pass | Pass | Pass | Fail | Fail |
| Creep | | | | | | |

D = Destructible

### Automotive Insulation Example

### Experimental Procedures

Table 4 shows the formula for Example 5, in parts. The materials listed were mixed in a beaker with an overhead mixer with a 1.5 inch diameter blade. The adhesive mix was coated with a #4 Mayer rod onto 1 mil Aluminum Foil sheets and dried at 75° C. for 4 minutes. The dry adhesive weight was 1.9-2.4 pounds/ream. Adhesive coated foil was laminated with a ChemInstruments HL-100 Hot Roll Laminator to a polyester nonwoven used in automotive insulation applications. The laminating conditions were 90 PSI, roller speed of 300 inches/min, and a hot roll temperature of 165° C. T-peel and modified elevated temperature creep testing were performed on the Aluminum Foil/nonwoven laminate after heat treatment of 185° C. for 8 minutes, simulating in-mold temperature conditions utilized when producing a molded insulated automotive part.

For the Modified Elevated Temperature Creep Test, an approximately three-inch section of a 1 inch wide strip of laminate was separated to create two unbonded ends, 3 inches in length. One surface of the free end of the laminate was affixed to a shelf in an oven pre-heated to 150° F. and a 50 gram weight was attached to the other free end. As Table 5 shows, the temperature was increased by 25° F. every 30 minutes until failure or 450° F. was attained.

TABLE 4
Adhesive Formula

| Material | Example 5 |
|---|---|
| Ethylene Acrylic Acid | 200 |
| copolymer dispersion, 28- | |
| 30% in water | |
| β-hydroxyalkylamide | 20 |
| crosslinker, used as a 33% | |
| solution in water | |
| Blue Dye Solution | 2 |
| Nano-scale wax emulsion | 10 |
| anti block agent, 24.5- | |
| 25.5% in water | |

### Results

Laminates using the inventive adhesive (Example 5, Table 4) pulled fibers from the nonwoven during the T-peel test, indicating an excellent bond to the non-woven. These laminates also maintained their structure, with the first substrate remaining bonded to the second substrate without decomposition of the adhesive or delamination of the substrates at temperatures up to about 200° C. This is a significant improvement over heat sealable films produced by coextruding ethylene acrylic acid copolymer layers on top of a polypropylene core, which can fail at temperatures of 80° C.

TABLE 5
Test Results

| T-Peel | | | | | | | | | | |
|---|---|---|---|---|---|---|---|---|---|---|
| (lbf/in) | Elevated Creep-30 minute soak at each temp | | | | | | | | | |
| 1.5 | 150° F. | 175° F. | 200° F. | 225° F. | 250° F. | 275° F. | 300° F. | 350° F. | 400° F. | 450° F. |
| | Pass | Pass | Pass | Pass | Pass | Pass | Pass | Pass | Pass | Pass |

Exemplary applications for bonded substrates using the present adhesive includes automotive/aerospace (heat shields, sound barriers, wire harnesses), furniture, packaging materials, electronic packaging materials, building and construction materials (flex duct, reflective insulation, acoustical, HVAC, facings for insulation), and safety and protective clothing. A particularly suited application for this adhesive is in the construction of an aluminum foil-polyester nonwoven laminate to serve as a thermal & acoustical barrier for automotive engine compartments and transmissions. The laminate construction is produced as a molded part and the bonding is accomplished as the part is being thermally molded. Alternatively, the laminated part may be formed with a hot roll rather than in a mold when the loft (thickness) of the nonwoven material is to be preserved.

The method of application of the adhesive to a surface can be by any of a number of ways known to those having ordinary skill in the art, such as, for example, brushing, spraying, roller coating, rotogravure coating, flexographic coating, flow coating, curtain coating, dipping, hot melt coating, extrusion, co-extrusion, similar methods, and combinations thereof.

It will be further understood that various changes in the details, materials, and arrangements of the parts which have been described and illustrated in order to explain the nature of this invention may be made by those skilled in the art without departing from the scope of the invention as expressed in the following claims.

1. A laminate comprising:
a first substrate;
a second substrate; and
a first adhesive between the first substrate and the second substrate,
the first adhesive comprising:
a polymer base comprising an ethylene and/or propylene copolymer; and
a crosslinking agent capable of crosslinking the base polymer.

2. The laminate according to claim 1, wherein the laminate requires a pull force of at least 0.5 lbs to separate the first substrate from the second substrate.

3. The laminate according to claim 1, wherein the first substrate remains bonded to the second substrate at temperatures up to about 100° C.

4. The laminate according to claim 1, further comprising a tackifier.

5. The laminate according to claim 4, where the tackifier is present in the ranges of between about 4 percent and about 50 percent by weight.

6. The laminate according to claim 1, wherein the crosslinking agent is selected from the group consisting of hydroxyl alkyl amides, melamines, melamine formaldehyde resins and aziridines.

7. The laminate according to claim 1, further comprising a first metallization layer applied to the first substrate.

8. The laminate according to claim 7, further comprising a second metallization layer applied to the first substrate, distal from the first metallization layer.

9. The laminate according to claim 8, further comprising a third substrate attached to the second substrate with a second adhesive.

10. The laminate according to claim 9, further comprising a fourth substrate attached to the third substrate with a third adhesive.

11. The laminate according to claim 10, further comprising a coating applied to the fourth substrate.

12. The laminate according to claim 10, wherein the second and third adhesives are the same as the first adhesive.

13. The laminate according to claim 1, wherein the first substrate remains bonded to the second substrate without decomposition of the first adhesive or delamination of the first and second substrates at temperatures up to 200° C.

14. The laminate according to claim 1, wherein the polymer base comprises between about 75 weight percent and about 99.99 weight percent of the adhesive and wherein the crosslinking agent comprises between about 0.01 weight percent and about 25 weight percent of the adhesive.

15. The laminate according to claim 14, wherein the crosslinking agent comprises between about 1 weight percent and about 15 weight percent of the adhesive.

16. The laminate according to claim 14, wherein an activation temperature for bonding the adhesive starts at about 80° C. and crosslinking occurs between about 25° C. and about 200° C.

17. The laminate to claim 1, wherein the polymer base comprises at least one selected from the group consisting of ethylene-(meth)acrylic acid, ethylene-vinyl acetate, ethylene-alkyl (meth)acrylate copolymers, propylene maleic anhydride copolymers, and chlorinated olefins.

18. A polymer adhesive comprising:
a polymer base comprising an ethylene and/or propylene copolymer; and
a crosslinking agent capable of crosslinking the polymer base.

19. The polymer adhesive according to claim 18, wherein the polymer base comprises between about 75 weight percent and about 99.99 weight percent of the adhesive and wherein the crosslinking agent comprises between about 0.01 weight percent and about 25 weight percent of the adhesive.

20. The polymer adhesive according to claim 19, wherein the crosslinking agent comprises between about 1 weight percent and about 15 weight percent of the adhesive.

21. The polymer adhesive according to claim 19, wherein an activation temperature for bonding the adhesive starts at about 80° C. and crosslinking occurs between about 25° C. and about 200° C.

22. The adhesive according to claim 18, further comprising a tackifier.

23. The adhesive according to claim 22, where the tackifier is present in the ranges of between about 4 percent and about 50 percent by weight.

24. The adhesive according to claim 18, wherein the crosslinking agent is selected from the group consisting of hydroxyalkyl amides, melamines, melamine formaldehyde resins, and aziridines.

25. The adhesive according to claim 18, wherein the polymer base comprises at least one selected from the group consisting of ethylene-(meth)acrylic acid, ethylene-vinyl acetate, ethylene-alkyl (meth)acrylate copolymers, propylene maleic anhydride copolymers, and chlorinated olefins.
